(19) United States
(12) Patent Application Publication
(10) Pub. No.: US 2016/0262173 A1
(43) Pub. Date: Sep. 8, 2016

(54) METHODS FOR UPLINK CHANNEL ACCESS IN WIRELESS LOCAL AREA NETWORKS

(71) Applicant: Samsung Electronics Co., Ltd, Suwon-si (KR)

(72) Inventors: Kaushik M. Josiam, Fort Worth, TX (US); Rakesh Taori, McKinney, TX (US)

(21) Appl. No.: 15/056,945

(22) Filed: Feb. 29, 2016

Related U.S. Application Data
(60) Provisional application No. 62/127,681, filed on Mar. 3, 2015.
(60) Provisional application No. 62/215,915, filed on Sep. 9, 2015.

(51) Int. Cl. H04W 72/12; H04B 7/04

(52) U.S. Cl. CPC H04W 72/1284; H04W 72/1236; H04W 72/1242; H04B 7/0452; H04W 84/12

(57) ABSTRACT

A method for operating a station (STA) in a wireless local area network (WLAN). The method comprises receiving a resource status request from an access point (AP) communicating with the STA, transmitting a resource status response including an access category (AC) information of UL data that is identified using a traffic identifier. The AC information corresponds to a set of DL queues and a set of UL queues configured at the AP to schedule the STA. The method further comprises receiving a trigger frame from the AP, wherein the trigger frame includes scheduling information of the UL data based on the AC information included in the transmitted resource status response to the AP and processing the scheduling information included in the trigger frame to transmit the UL data to the AP.

### CROSS-REFERENCE TO RELATED APPLICATION(S) AND CLAIM OF PRIORITY

This application claims priority to U.S. Provisional Patent Application No. 62/127,681 entitled “Methods for Uplink Channel Access in Wireless Local Area Networks,” filed on Mar. 3, 2015 and U.S. Provisional Patent Application No. 62/215,915 entitled “Methods for Uplink Channel Access Is Wireless Local Area Networks” filed on Sep. 9, 2015. The above-identified provisional patent application is hereby incorporated by reference in its entirety.

### TECHNICAL FIELD

This disclosure relates generally to wireless local area networks (WLANs). More specifically, this disclosure relates to uplink channel access in WLAN systems.

### BACKGROUND

The IEEE 802.11ac supports multi-user (MU) transmission using spatial degrees of freedom via multi user-multiple input-multiple-output (MU-MIMO) in a downlink direction from an access point (AP) to stations (STAs). To improve efficiency, the IEEE 802.11ax has considered using both orthogonal frequency division multiple access (OFDMA) and/or MU-MIMO in both downlink and uplink directions that is in addition to supporting frequency and spatial multiplexing from an AP to multiple STAs, transmissions from multiple STAs to the AP are also supported. The AP being a central node in a network receives traffic for multiple STAs and can decide if the AP wants to transmit using MU or single user (SU) modes to users or receive using uplink MU from the multiple STAs. Since a channel is contended in the IEEE 802.11 system, an introduction of an uplink mode requires consideration of channel access rules. Therefore, an uplink channel access scheme for an uplink MU transmission and an STA behavior in response to the uplink transmission based on access categories and their involvement in the channel access is needed to improve performance and throughput in WLAN system.

### SUMMARY

Embodiments of the present disclosure provide methods for uplink channel access in WLAN systems.

In one embodiment, a station (STA) in a wireless local area network (WLAN) is provided. The STA includes a transceiver configured to receive a resource status request from an access point (AP) communicating with the STA, transmit a resource status response including quality of service (QoS) access category (AC) information of UL data that is identified using a traffic identifier. The AC information corresponds to a set of UL queues configured at the AP to schedule the STA. The transceiver is further configured to receive a trigger frame from the AP. The trigger frame includes scheduling information of the UL data based on the AC information included in the transmitted resource status response to the AP. The STA includes at least one processor configured to process the scheduling information included in the trigger frame to transmit the UL data.

In another embodiment, an access point (AP) in a wireless local area network (WLAN) is provided. The AP includes at least one processor configured to configure a set of downlink (DL) queues and a set of uplink (UL) queues. Each DL and UL queues are identified based on an access category (AC). The AP includes a transceiver configured to transmit a resource status request to a set of stations (STAs) communicating with the AP, receive a resource status response including the buffer length for each of the access category (AC) information of UL data from the set of STAs. The AC information corresponds to the set of DL queues and the set of UL queues configured at the AP to schedule the set of STAs. The transceiver is further configured to transmit a trigger frame to the set of STAs. The trigger frame includes scheduling information of the UL data based on the AC information included in the received resource status response from the set of STAs.

In yet another embodiment, a method for operating a station (STA) in a wireless local area network (WLAN) is provided. The method includes receiving a resource status request from an access point (AP) communicating with the STA and transmitting a resource status response including quality of service (QoS) access category (AC) information of UL data that is identified using a traffic identifier. The AC information corresponds to a set of UL queues configured at the AP to schedule the STA for an UL MU transmission. The method further includes receiving a trigger frame from the AP, wherein the trigger frame includes scheduling information of the UL data based on the AC information included in the transmitted resource status response to the AP and processing the scheduling information included in the trigger frame to transmit the UL data to the AP.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, include, be included within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to illustrative embodiments of the present disclosure;

FIG. 2A illustrates an example AP according to illustrative embodiments of the present disclosure;

FIG. 2B illustrates an example STA according to illustrative embodiments of the present disclosure;

FIG. 3 illustrates an example signal flowchart for management of downlink and uplink multi user (MU) transmissions according to illustrative embodiments of the present disclosure;

FIG. 4 illustrates an example access category queues for downlink and uplink at an access point (AP) according to illustrative embodiments of the present disclosure;

FIG. 5 illustrates an example one uplink queue at the AP for contention according to illustrative embodiments of the present disclosure;

FIG. 6 illustrates an example signal transmissions for uplink MU transmissions according to illustrative embodiments of the present disclosure; and

FIG. 7 illustrates an example signal flowchart for the uplink MU transmissions according to illustrative embodiments of the present disclosure.

### DETAILED DESCRIPTION

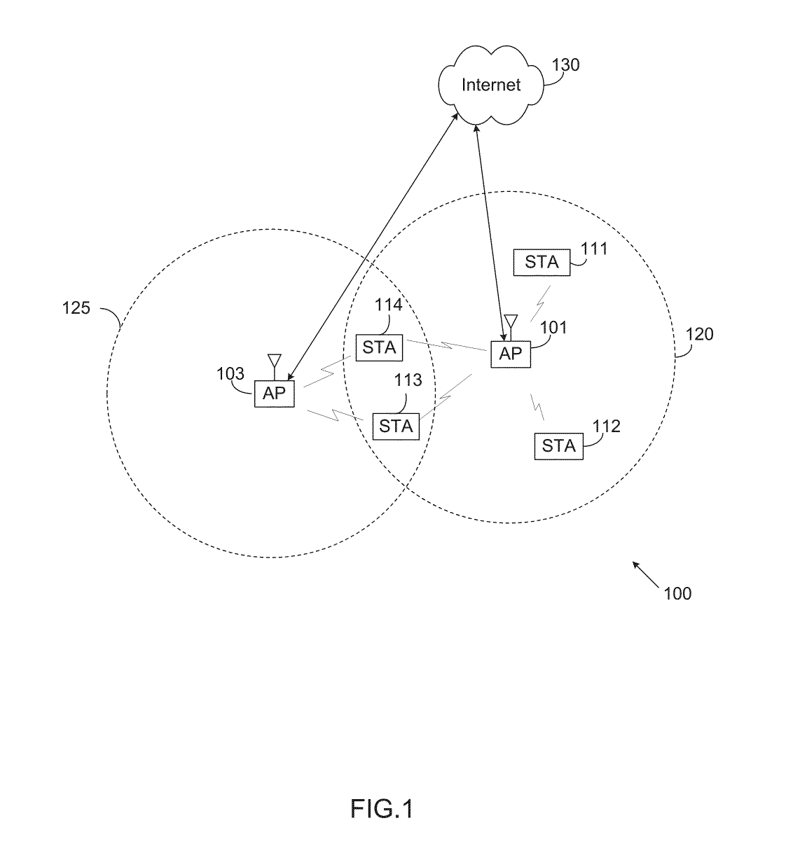

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

FIG. 1 illustrates an example wireless network 100 according to this disclosure. The embodiment of the wireless network 100 illustrated in FIG. 1 is for illustration only. Other embodiments of the wireless network 100 could be used without departing from the scope of this disclosure.

As illustrated in FIG. 1, the wireless network 100 includes APs 101 and 103. The APs 101 and 103 communicate with at least one network 130, such as the Internet, a proprietary Internet Protocol (IP) network, or other data network.

The AP 101 provides wireless access to the network 130 for a plurality of stations (STAs) 111-114 within a coverage area 120 of the AP 101. The APs 101-103 may communicate with each other and with the STAs 111-114 using WiFi or other WLAN communication techniques.

Depending on the network type, other well-known terms may be used instead of “access point” or “AP,” such as “router” or “gateway.” For the sake of convenience, the term “AP” is used in this patent document to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” “user device,” or “user.” For the sake of convenience, the terms “station” and “STA” are used in this patent document to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are illustrated as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programing for management of UL MU transmissions in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

In some embodiments, an AP in a WLAN configures a set of DL queues and a set of uplink UL queues, wherein each DL and UL queues are identified based on an access category (AC). In such embodiment, the AP transmits a resource status request to a set of stations (STAs) communicating with the AP, receive a resource status response including access category (AC) information of UL data queued at the STAs from the set of STAs, wherein the AC information corresponds to the set of DL queues and the set of UL queues configured at the AP to schedule the set of STAs, and transmits a trigger frame to the set of STAs, wherein the trigger frame includes scheduling information of the UL data based on the AC information included in the received resource status response from the set of STAs.

In some embodiments, an AP determines duration of a transmission opportunity (TXOP) and a size of a medium access control (MAC) service data unit (MSDU) based on the AC information, and the transceiver is further configured to receive the UL data from the set of STAs over a granted UL access channel using a UL multi-user (UL-MU) transmission.

In some embodiments, an AP transmits a multiuser-block acknowledgement (MU-BA) to the set of STAs that have transmitted the UL data to the AP, wherein the MU-BA includes one or more acknowledgements that indicates a successful reception of the UL data from the set of STAs. In such embodiments, the AC information of the UL data identifies a traffic priority of the UL data in accordance with a level of quality of service required by the UL. The set of UL queues is identified by single AC information indicating a single traffic priority of the UL data to be transmitted to the AP. In addition, at least one of the duration of the TXOP, the size of the MSDU, and the AC information may be differently configured for the set of DL queues and the set of UL queues.

In some embodiments, a station (STA) in a wireless local area network (WLAN) receives a resource status request from an access point (AP) communicating with the STA, transmits a resource status response including access category (AC) information of UL data to be transmitted to the AP, wherein the AC information corresponds to a set of DL queues and a set of UL queues configured at the AP to schedule the STA, and receives a trigger frame from the AP, wherein the trigger frame includes scheduling information of the UL data based on the AC information included in the transmitted resource status response to the AP. In such embodiments, the STA processes the scheduling information included in the trigger frame to transmit the UL data.

In some embodiments, a station (STA) transmits the UL data corresponding to the AC information, identified by the traffic identifier (TID), based on the scheduling information included in the received trigger frame over a granted UL access channel using a UL-multiuser (UL-MU) transmission and receives a multiuser-block acknowledgement (MU-BA) from the AP, wherein the MU-BA includes one or more acknowledgements indicating a successful transmission of the UL data to the AP. In such embodiments, the scheduling information included in the trigger frame comprises duration of a transmission opportunity (TXOP) and a size of a medium access control (MAC) service data unit (MSDU) for the UL data to be transmitted to the AP. In such embodiments, the AC information of the UL data identifies a traffic priority of the UL data in accordance with a level of quality of service required by the UL data.

In some embodiments, an STA transmits another UL data to the AP until duration of an transmit opportunity (TXOP) expired after transmitting the scheduled UL data corresponding to the AC information included in the transmitted resource status response for the duration of the TXOP, the other UL data corresponding to different AC information than the scheduled UL data. In such embodiments, the UL data transmitted in the duration of the TXOP includes different ACs information and the duration of the TXOP is shared in at least one of a time domain, a frequency domain, and a spatial domain.

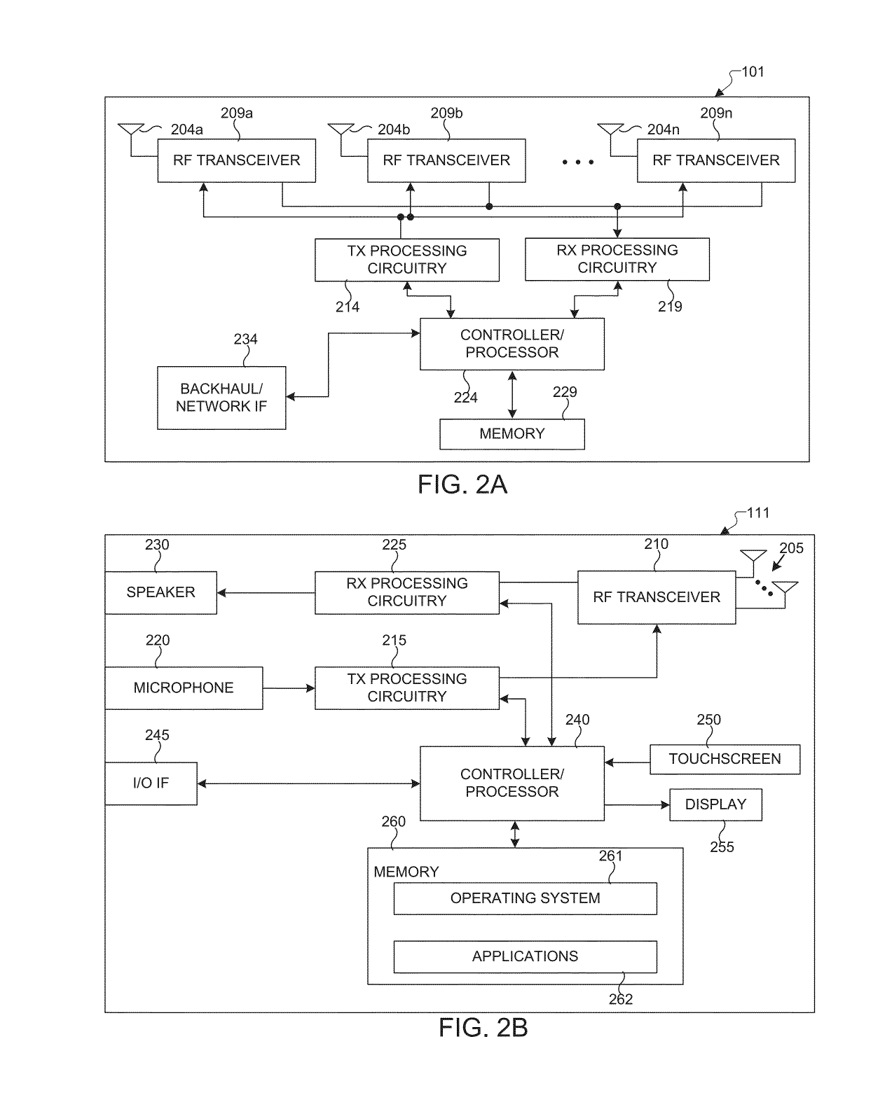

FIG. 2A illustrates an example AP 101 according to this disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

As illustrated in FIG. 2A, the AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234.

The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing. In some embodiments, the RX processing circuitry 219 transmits a resource status request to a set of stations (STAs) communicating with the AP, receive a resource status response including access category (AC) information of UL data from the set of STAs, wherein the AC information corresponds to the set of DL queues and the set of UL queues configured at the AP to schedule the set of STAs, and transmits a trigger frame to the set of STAs, wherein the trigger frame includes scheduling information of the UL data based on the AC information included in the received resource status response from the set of STAs.

In another embodiment, an AP transmits a multiuser-block acknowledgement (MU-BA) to the set of STAs that have transmitted the UL data to the AP, wherein the MU-BA includes one or more acknowledgements that indicates a successful reception of the UL data from the set of STAs. In such embodiments, the AC information of the UL data identifies a traffic priority of the UL data in accordance with a level of quality of service required by the UL.

The TX processing circuitry 214 transmits analog or digital data (such as voice data, web data, e-mail, or interactive video game data) from the controller/processor 224. The TX processing circuitry 214 encodes, multiplexes, and/or converts the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction.

In one embodiment, the controller/processor 224 configures a set of DL queues and a set of uplink UL queues, wherein each DL and UL queues are identified based on an access category (AC).

In another embodiment, the controller/processor 224 determines duration of a transmission opportunity (TXOP) and a size of a medium access control (MAC) service data unit (MSDU) based on the AC information, and the transceiver is further configured to receive the UL data from the set of STAs over a granted UL access channel using a UL-MU transmission. In such embodiments, the AC information of the UL data identifies a traffic priority of the UL data in accordance with a level of quality of service required by the UL. The set of UL queues is identified by single AC information indicating a single traffic priority of the UL data to be transmitted to the AP. In addition, at least one of the duration of the TXOP, the size of the MSDU, and the AC information may be differently configured for the set of DL queues and the set of UL queues.

Any of a wide variety of other functions could be supported in the AP 101 by the controller/processor 224. In some embodiments, the controller/processor 224 includes at least one microprocessor or microcontroller.

The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver.

The memory 229 is coupled to the controller/processor 224. Part of the memory 229 could include a RAM, and another part of the memory 229 could include a Flash memory or other ROM.

As described in more detail below, the AP 101 may include circuitry and/or programing for using or managing uplink multi-user (UL MU) transmission in a WLAN system. Although FIG. 2A illustrates one example of AP 101, various changes may be made to FIG. 2A. For example, the AP 101 could include any number of each component illustrated in FIG. 2A. As a particular example, an access point could include a number of interfaces 234, and the controller/processor 224 could support routing functions to route data between different network addresses. As another particular example, while illustrated as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B illustrates an example STA 111 according to this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

As illustrated in FIG. 2B, the STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260, The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming

RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240, The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In some embodiments, the RF transceiver 210 receives a resource status request from an access point (AP) communicating with the STA, transmit a resource status response including access category (AC) information of UL data to be transmitted to the AP, wherein the AC information corresponds to a set of DL queues and a set of UL queues configured at the AP to schedule the STA, and receives a trigger frame from the AP, wherein the trigger frame includes scheduling information of the UL data based on the AC information included in the transmitted resource status response to the AP.

In some embodiments, the RF receiver 210 transmits the UL data in corresponding to the AC information included in the transmitted resource status response based on the scheduling information included in the received trigger frame over a granted UL access channel using a UL-multiuser (UL-MU) transmission and receives a multiuser-block acknowledgement (MU-BA) from the AP, wherein the MU-BA includes one or more acknowledgements indicating a successful transmission of the UL data to the AP.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to provide management of UL MU transmissions in WLANs. In some embodiments, the controller/processor 240 includes at least one microprocessor or microcontroller.

The controller/processor 240 is also capable of executing other processes and programs resident in the memory 260, such as operations for using or managing UL MU transmission in a WLAN system. The controller/processor 240 can move data into or out of the memory 260 as required by an executing process. In some embodiments, the controller/processor 240 is configured to execute a plurality of applications 262, such as applications for MU communications, including management of UL MU transmissions in WLANs. The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers.

In some embodiments, the controller/processor 240 process scheduling information included in a trigger frame to transmit UL data to an AP. In such embodiments, the scheduling information included in the trigger frame comprises duration of a transmission opportunity (TXOP) and a size of a medium access control (MAC) service data unit (MSDU) for the UL data to be transmitted to the AP. The AC information of the UL data identifies a traffic priority of the UL data in accordance with a level of quality of service required by the UL data.

The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites.

The memory 260 is coupled to the controller/processor 240, Part of the memory 260 could include a random access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

When an uplink transmission from STA follows a downlink allocation to STAs, at least one of the STAs scheduled on an uplink has traffic to send in the same access category (AC) as the downlink that won a contention for a channel according to enhanced distributed channel access (EDCA) rules. Furthermore, when the uplink follows a downlink allocation, the channel is won, according to the EDCA rules, for an access category with no distinction if the traffic is for the uplink or downlink.

A modification of a medium access control (MAC) service data unit (MSDU) limit and time duration limits per transmission opportunity (TXOP) are considered to accommodate different flavors of an uplink transmission. When STAs respond to an uplink trigger frame, transmit and receive addresses may not be necessary in transmitted frames. A contention mechanism of an uplink access category queues is different from those of the downlink and may be time varying or set to start based on fulfilling requirements on the distinctness of received resource requests.

Three types of uplink transmissions have been identified for consideration in an 802.11ax high efficiency wireless LAN system; an uplink followed by a downlink allocation, an uplink by a stand-alone trigger frame, and an uplink with random access characteristic.

For uplink transmissions, carrier sense multiple access (CSMA) contention rules based on an EDCA mechanism need reassessment. According to embodiments of the present disclosure, the updates required to the CSMA rules to accommodate uplink transmission consider unique nature of origin at the AP and involve granted channel access to multiple STAs.

In an EDCA mechanism, a TXOP is obtained by a station through a channel access procedure using access parameters for a particular class of traffic for which the TXOP will be used. Once the TXOP is obtained, the station may continue to transmit data, control, and management frames and receive response frames, provide frame sequence duration that does not exceed a TXOP limit set for an AC.

For background (AC_BK) and best effort (AC_BE)-TXOP limit is 0 which implies that only one medium access layer (MAC) service data unit (MSDU) may be transmitted within the TXOP limit. An MSDU may map to multiple MAC protocol data units (MPDUs) via a fragmentation that may be transmitted within one TXOP. In one example, for video (AC_VI)-TXOP limit is 3.008 ms. In another example, for voice (AC_VO)-TXOP limit is 1.504ms. In such examples, those numbers haven't changed from the IEEE 802.11e amendment to the IEEE 802.11 specifications.

The current TXOP rules allow sharing the TXOP as long as a priority of a queue that won the contention is maintained and was introduced for multi-user (MU) physical layer convergence layer (PLCP) protocol data units (PPDUs) in the IEEE 802.11ac where traffic of a different category providing the PPDU duration is not increased beyond that needed to carry the primary AC traffic alone.

A sharing TXOP cannot be extended to schedule different ACs for a downlink and uplink. The sharing of AC was agreed for MU where different spatial streams could carry different AC traffics in the same time/frequency span. Neither the time or frequency span could be different for the different AC traffics.

Even if an uplink is treated as a response to downlink physical layer control protocol (PLCP) protocol data units (PPDUs) transmitted because in the IEEE 802.11ac, a TXOP limit of 0, a transmitter is permitted to send a single MU PPDU, receive an immediate response, and poll the remaining users for their block acknowledgement (BA) frames. In this instance, a sequential polling is defined (such as not MU polling).

In some embodiments, when an uplink follows a downlink allocation, at least one of STAs scheduled on an uplink has traffic to send in the same access category (AC) as a downlink that won the contention for a channel according to EDCA rules. The channel contention is based on a backoff mechanism for each of access category queues at an AP. Once channel access is won for one of the access categories, the AP can schedule uplink MU traffic to follow the downlink where at least one of the STAs scheduled has traffic that belongs to the same access category that won the contention for the downlink. The STAs scheduled for the downlink can be different from those scheduled for the uplink. In such embodiments, at least one STA at the downlink and one STA at the uplink has traffic belonging to the same access category.

In some embodiments, when an uplink follows a downlink allocation, a channel is won, according to EDCA rules, for an access category. An access category that wins the contention can be either downlink or uplink traffic. The channel contention is based on a backoff mechanism for each of access category queues for the downlink and uplink at an AP. Once channel access is won for one of the access categories, the AP can schedule uplink MU traffic to follow the downlink where at least one of the STAs has traffic to send or receive in the access category that won contention for the channel at the AP. The STAs scheduled for the downlink can be different from those scheduled for the uplink.

In some embodiments, when an AP wins channel contention using EDCA rules for a specific access category, TXOP duration, in seconds, is not dependent on the access category that won channel access. The TXOP can be chosen by the AP from a set of specific values for use in scheduling downlink and uplink MU data within the TXOP. When an STA wins channel contention using the EDCA rules for the specific access category, the TXOP duration, in seconds, is dependent on the access category that won channel access. More specifically, the TXOP value to be chosen can be restricted in several ways without deviating from the intent of this embodiment. In one example, the TXOP value chosen can be subjected to a maximum limit that the AP can use for one channel contention. Furthermore, a selection of the TXOP value can be imposed when the AP schedules a downlink followed by an uplink frame or just an uplink frame. In another example, for other types of SU or downlink MU transmissions, the AP can use the same EDCA rules where the TXOP rules are not delinked from the access categories.

In some embodiments, a TXOP limit per access category can be subjected to maximum time period and/or allow transmissions of more than one MSDU. In such embodiments, a transmission of downlink MSDUs to STAs and uplink MSDUs from STAs within the same TXOP is allowed even when an access category belongs to best effort (AC_BE) or background (AC_BK) traffic. The restriction on a number of MSDUs to be transmitted for the AC_BE or the AC_BK traffic can be removed without increasing the TXOP limit. The TXOP limit is associated per access category with higher time periods allowing for support of different transmission modes, when such transmissions are initiated at the AP. While this increased time limit for the TXOP per access category can be applied to all IEEE 802.11 STAs and APs, restrictions could be imposed where the increased time limit applies only for those transmissions from the AP. In one example, MSDU limits can be completely eliminated for all access categories while retaining a limit on the duration of the TXOP for different access categories.

In some embodiments, in response to an UL MU trigger frame, STAs can transmit MSDUs without a receiver address (RA) or transmitter address (TA) in an MAC header in the resources indicated by an AP in the UL MU trigger frame. Uplink data transmitted from the STA responding to the trigger frame from the AP is a specific instance where the context of the transmission is clear. The STA is clearly identified in the trigger frame. The AP knows the resources that is assigned to the STA and expects no other transmission in the specified time, frequency, or spatial resource. Hence, a need for a TA or an RA in the MAC header of an MPDU is obviated so that the MAC header can thus be compressed.

In some embodiments, a transmit opportunity can allow different types of transmissions from different access categories as long as a TA or an RA identified in a header (such as in MAC or PHY layer) belongs to that of an AP. When an uplink is initiated by a trigger frame, the TA is clearly that of the AP to which STAs respond with their frame in which the RA matches that of the AP. In such embodiments, the AP is the destination of any uplink data transmissions from the STAs. Uplink transmissions initiated by a trigger frame are distinguished from those that are transmitted as a response to a downlink data transmission like an ACK frame or block ACK (BA) frame where the AP could be the one responding to the transmission from STAs.

In some embodiments, a TXOP won by gaining channel access based on a particular access category can be shared in frequency or time resources with other categories that have the same or lower in priority to a scheduled AC. The TXOP may include frequency and time resource sharing in addition to the spatial sharing of the TXOP. In such embodiments, a PPDU duration may be the same for all the users transmitting the UL MU data. In one example, when a TXOP sharing is restricted to only frequency and spatial resource domains, then the PPDU duration of the access categories scheduled for the transmission from all STAs scheduled in the UL MU transmission is set to be same. In another example, when a TXOP is shared in the time resource domain in addition to the frequency and spatial resource domains, the tight requirement of PPDU duration is maintained in frequency and spatial resource domains and can be differentiate across different time intervals within the same TXOP.

In some embodiments, if an STA responds to a trigger frame (TF) with an UL MU PPDU, MPDUs that belong to an AC aforementioned in the trigger frame gets a level of priority. The AC is indicated by a TID carried in the trigger frame. If UL transmission duration specified in the TF is larger than an amount of traffic at the STA for the indicated AC, multiple frames may be transmitted as long as the multiple frames belong to the same AC. Frames pending in other AC may also be transmitted, if no more frames in the specified AC are available in order to utilize the specified UL PPDU duration.

In some embodiments, an STA on receiving a TF from an AP responds if the STA address indicated in the TF matches the STA's address, even if a channel is sensed as busy in duration of an inter-frame spacing required before starting to transmit uplink data of the STA to the AP, ignoring CCA rules. A channel sense mechanism is to be suspended at the STA when responding to a correctly received uplink MU TF with the STAs address indicated within.

In some embodiment, an STA on receiving a TF from an AP responds if the STA address indicated in the TF matches the STA's address, if virtual carrier sense mechanisms network allocation vector (NAV) was set by the AP that sent the TF. When the NAV is set by nodes other than the AP that sent the TF, the STA response can be calibrated based on multiple parameters. In one example, if the TF is a UL MU block ACK (BA) request, the STA ignores the NAV and transmits the BA anyway. In another example, if the TF calls UL MU data, the STA can use spatial re-use rules or to establish if responding to the UL MU transmission will cause interference to the ongoing transmission that necessitated the NAV. In yet another example, spatial re-use mechanisms involve measurements based on the received and fields in the decoded packets that contain parameters to help the STA assess if the STA's transmission impacts an ongoing transmission. In such example, these fields can be carried in an enhanced request to send (RTS)/enhanced clear to send (CTS) response or in high efficiency-signaling-A (HE-SIG-A). In yet another example, if the TF is a random access trigger frame, the STA ignores the NAV and transmits on a resource of the random access trigger frame anyway. In yet another example, the STA checks channel availability or performs an energy detection in a unit of the 20 MHz segments that contain a resource unit that may be used to transmit the UL MU data.

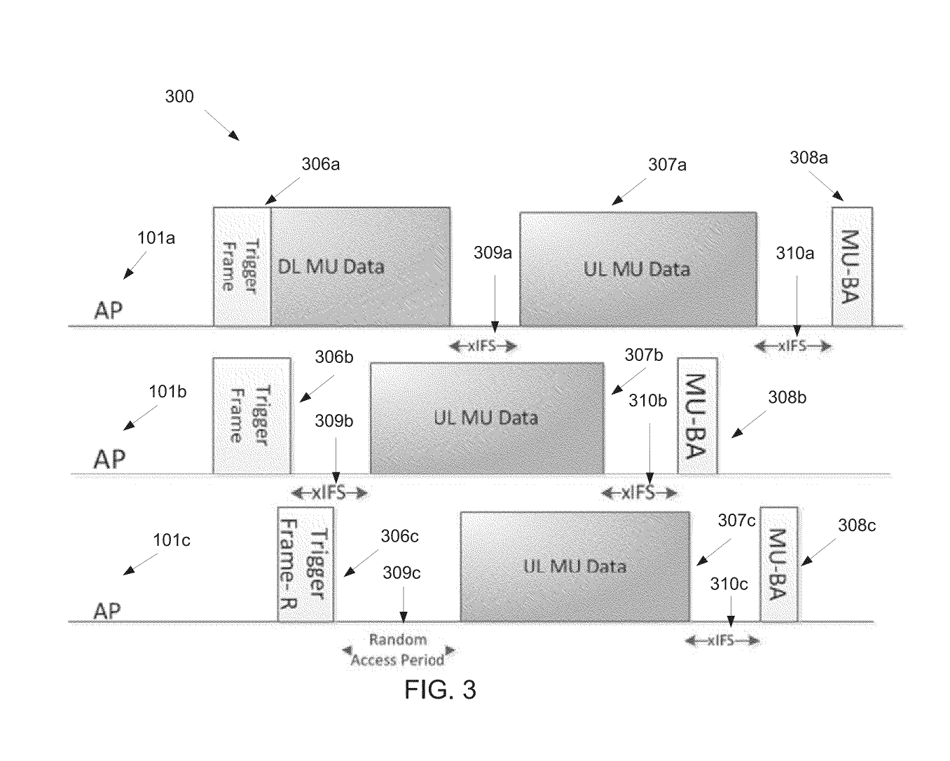

FIG. 3 illustrates an example signal flowchart 300 for management of downlink and uplink multi user (MU) transmissions according to illustrative embodiments of the present disclosure. The embodiment of the signal flowchart 300 for management of downlink and uplink MU transmission illustrated in FIG. 3 is for illustration only. Other embodiments of the signal flowchart 300 could be used without departing from the scope of this disclosure.

As illustrated in FIG. 3 the STAs 111-113 and the APs 101a, 101b, 101c are configured to perform uplink (UL) MU transmission and reception, respectively, using a UL MU transmission protocol. The UL transmission from STAs 111-114 to APs 101a, 101b, 101c in WLANs is initiated by the APs 101a, 101b, and 101c. More specifically, the APs 101a perform downlink and uplink transmissions, the AP 101b perform an uplink transmission only, and the AP 101c performs an uplink transmission with a random access procedures.

The wireless medium in local area networks like IEEE 802.11 is accessed by contention from all devices in the network using a carrier sense multiple access (CSMA) protocol. For UL transmissions, the APs 101a, 101b, 101c gains access to or “wins” the wireless medium access and transmits trigger frames 306a, 306b, 306c indicating that this transmission opportunity (TXOP) is reserved for the UL transmission from multiple STAs. The trigger frames 306a, 306, 306c identify which STAs are to transmit the UL data. The trigger frames 306a, 306b, 306c is a broadcast frame which can be decoded by all STAs 111-113 in the listening or hearing range of the APs 101a, 101b, 101c. On decoding the trigger frames 306a, 306b, 306c, if the address of the STAs listed in the trigger frames 306a, 306b, 306c matches the STAs address, the STAs 111-113 transmits their data 307a, 307b, 307c, a time duration 309a, 310a, 309b, 310b, 309c, 310c (such as inter-frame spacing of x (xIFS)) after receiving the trigger frames 306a, 306b, 306c using the resource specified by the trigger frames 306a, 306b, 306c. All STAs 111-113 addressed in the trigger frames 306a, 306b, and 306c begin transmissions after xIFS time durations 309a, 310a, 309b, 310b, 309c, 310c after receiving the trigger frames 306a, 306b, 306c. The xIFS durations 309a, 310a, 309b, 310b, 309c, 310cspecify a pre-determined inter-frame spacing where the value x is to be determined. In an example, the xIFS can be a short inter-frame spacing (SIFS). After receiving the data from each of the STAs 111-113, the APs 101a, 101b, 101cmay transmit MU-block acknowledgements (BAs) 308a, 308b, 308cto the STAs 111-113 scheduled in the UL frame. The MU-BA transmissions 308a, 308b, 308c can occur an xIFS duration 310a, 310b, 310c after receiving the end-of-frame signaling from each of the STAs 111-113 scheduled in the UL MU transmissions 307a, 307b, 307c.

In some embodiments, the APs 101a, 101b, 101c need to know which of the STAs 111-113 have traffic to send, which of the STAs 111-113 can be scheduled together in the UL transmission, whether to use OFDMA or MU-MIMO. To know whether the STAs 111-113 have traffic to send, the APs 101a, 101b, 101ctransmit a buffer status request message and in response, receives the buffer status response message or report which indicates the amount of traffic the STAs 111-113 have to transmit to the AP 101a, 101b, 101c. The buffer status response message or report can be a Quality of Service (QoS) null frame. Additionally, the STAs 111-113 can also include (or piggyback) their buffer status response with one or more data transmissions to the AP 101 by placing the buffer status in the QoS header fields of the QoS data frame.

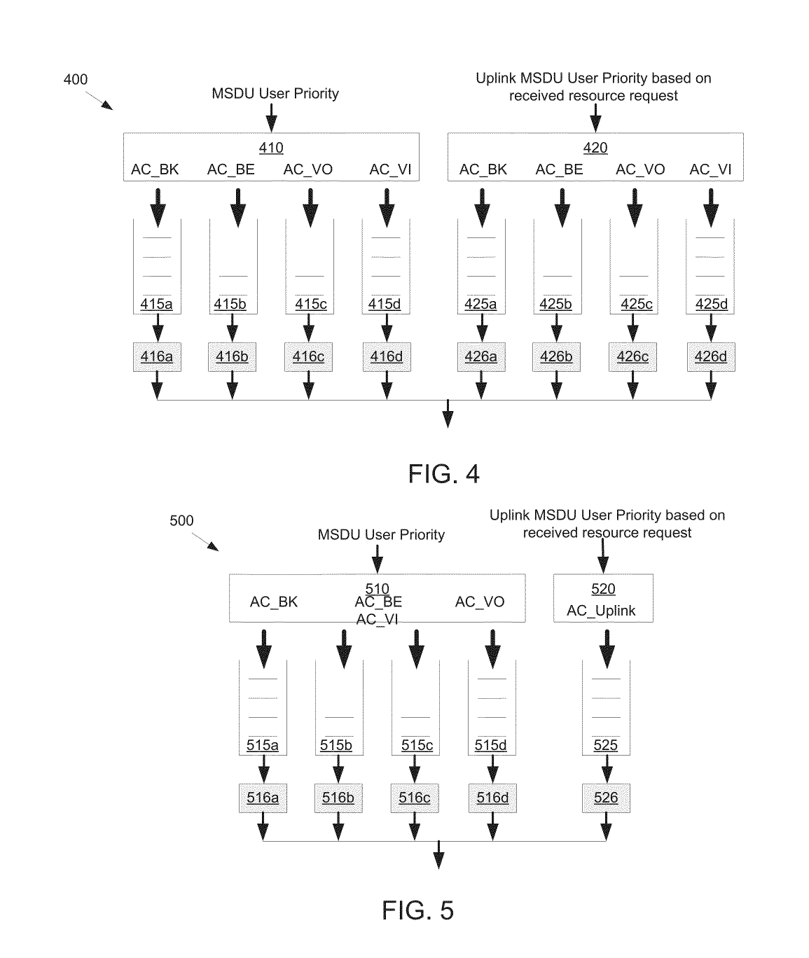

FIG. 4 illustrates example access category queues 400 for downlink and uplink at an access point (AP) according to illustrative embodiments of the present disclosure. The embodiment of the access category queues 400 for the downlink and uplink at the AP illustrated in FIG. 4 is for illustration only. Other embodiments of the access category queues 400 could be used without departing from the scope of this disclosure.

As illustrated in FIG. 4, the access category queue 400 comprises a priority mapping block 410, 420, a set of transmit queues for access categories 415a, 415b, 415c, 415d, 425a, 425b, 425c, 425d, and a set of per QUEUE EDCAs 416a, 416b, 416c, 416d, 426a, 426b, 426c, 426d. At the priority mapping block 410, input traffic (such as MSDU) is classified into each access class such as AC_BK (such as access class for background), AC_BE(such as access class for best effort), AC_VO (such as access class for voice), and AC_VI (such as access class for video) with MSDU user priority based on incoming traffic. Similarly, uplink MSDU is classified into each access class such as AC_BK, AC_BE, AC_VD, and AC_VI with MSDU user priority based on received resource request. Each of classified traffic is buffered into different queues that are predetermined. For example, a traffic that is classified into AC_BK is buffered into the transmit queue 415a.

As illustrated in FIG. 4, the access category queues 415a, 415b, 415c, 415d, 425a, 425b, 425c, 425d, and TXOP duration per access category for an uplink are considered separate from those of downlink with contention window parameters and queue at an AP.

The AP maintains a distinct contention queue for uplink and downlink transmissions per access categories (such as 410, 420) and runs channel access protocol (such as EDCA). The contention queues 425a, 425b, 425c, 425d of the different access categories such as AC_BK, AC_BE, AC_VO, and AC_VI (such as 420) for the uplink is populated based on the received resource requests from STAs while the downlink contention queues 415a, 415b, 415c, 415d of access categories such as AC_BK, AC_BE, AC_VO, and AC_VI (such as 410) are populated by the incoming traffic from the network. The access category queues 415a, 415b, 415c, 415d for the downlink and 425a, 425b, 425c, 425d for the uplink both contend for the channel if the access queues 415a, 415b, 415c, 415d, 425a, 425b, 425c, 425d are not empty and upon gaining access, a scheduler can assign resources and share the TXOP based on the access queues for the downlink and uplink, and the access category that won the contention.

In some embodiments, an access category queue and TXOP duration per access category for an uplink and downlink can be separately maintained. An uplink queue per access category is populated by the received resource requests from an AP. An uplink trigger frame is sent for the access category of uplink data that won the contention. The TXOP is shared with the access category that has the same or lower priority than the access category of the uplink data that won contention. If the TXOP cannot be shared i.e., if no other resource requests are received and the uplink queues for the other access categories are empty, the AP may choose not to send the uplink TF even if the access category wins contention. An AP scheduler may not transmit a TF when only one STA is to be scheduled using an uplink trigger frame.

In some embodiments, a decision to transmit an uplink TF is to be determined at an AP, on the basis of a number of distinct resource requests received where distinct is emphasized to mean different STAs and/or different access categories. In one example, the distinct resource requests can mean only different STAs and not access categories.

In some embodiments, a contention mechanism of an uplink access category queues may be time varying or set to start based on fulfilling requirements on the distinctness of the received resource requests. In one example, target transmission times for the uplink TF may be advertised either in a beacon or in a preceding uplink TF transmission. The contention mechanism for the uplink queues is triggered when the current system is close to or has exceeded the target transmission time. In another example, the contention mechanism for the uplink queues can be triggered based on the class of access categories for which the resource request is to be transmitted. The contention may start when resource requests for the access category of the class voice (AC_VO) or video (AC_VI) are received and when other resource requests for the best effort (AC_BE) or background (AC_BK) access category have been previously received. If only AC_BE or AC_BK access categories are present, then the contention for the uplink data may not begin unless a threshold number of distinct resource requests have been received. In yet another example, the contention to gain channel access for transmitting the uplink trigger frame is triggered if the number of distinct resource requests exceed a specified threshold.

FIG. 5 illustrates an example one uplink queue 500 at the AP for contention according to illustrative embodiments of the present disclosure. The embodiment of the uplink queue 500 at the AP for contention illustrated in FIG. 5 is for illustration only. Other embodiments of the uplink queue 500 could be used without departing from the scope of this disclosure.

As illustrated in FIG. 5, the one uplink queue 500 comprises a priority mapping block 510, 520, a set of transmit queues for access categories 515a, 515b, 515c, 515d, 525, and a set of per QUEUE EDCAs 516a, 516b, 516c, 516d, 526. At the priority mapping block 510, input traffic (such as MSDU) is classified into each access class such as AC_BK (such as access class for background), AC_BE(such as access class for best effort), AC_VO (such as access class for voice), and AC_VI (such as access class for video) with MSDU user priority. However, uplink MSDU is classified into a single access class such as AC_Uplink with MSDU user priority based on received resource request.

As illustrated in FIG. 5, an AP maintains one uplink queue irrespective of access categories. The resource requests received from STAs are all queued up in one uplink queue as illustrated in FIG. 5. In such instance, the resource request format may not have enough granularities to identify the access categories or if the uplink MU transmissions are restricted to support access categories lower than AC_BE. In one example, an AP begins contention if the number of distinct resource requests exceeds a specified threshold with the contention parameters related to the highest access category. In another example, the AP begins contention of a wireless channel for uplink data using the same parameters as that of AC_BE and transmits an uplink TF when the AP gains channel access.

In some embodiments, a channel contention at an AP is based on EDCA with no differentiation between uplink and downlink access categories. Access category queues at the AP are populated both by incoming traffic and uplink resource requests. When a channel access is won, another parameter determines whether the won channel is to be used for an uplink and downlink. In one example, the parameter could be the number of distinct resource requests received or the access category that won the channel contention or is just an AP scheduling decision.

In some embodiments, a STA that receives an uplink TF and transmits uplink data in response to the TF resets a channel contention window after the transmission to begin a fresh round of contention for the traffic remaining to be sent in a queue of the STA. The STA treats an uplink channel access granted by an AP no different from the channel access won by the contention and observes the same protocol to reset the contention parameters as an IEEE 802.11 node (such as AP and STA) after transmitting on a contended channel access.

STAs that respond to an UL MU trigger frame with data re-initializes EDCA state variables. In one example, for successful transmissions of frames belonging to an AC involved in UL MU, a value of CW[AC] is reset to CWmin[AC]. For failed transmissions, the value of CW[AC] is increased and set to (CW[AC]+1)×2 −1 until CWmax[AC] is reached and remains unchanged for any retires. In such examples, a back-off procedure according to the updated CW[AC] is performed.

In some embodiments, if frames belonging to more than one AC are multiplexed in an UL MU PPDU, all ACs that were involved in an UL transmission re-initializes EDCA state variables and invoke back-off procedures after the transmission of the UL MU PPDUs.

In some embodiments, STAs on receiving a TF sets the NAV to countdown the duration indicated in the TF freezes the EDCA state variables for all ACs. If the STA is addressed in the TF and responds with data frames on an uplink to an AP, the STA restarts the EDCA state variables for the ACs not involved in the uplink MU transmission.

In some embodiments, STAs on receiving a TF freezes EDCA state variables for all ACs to the value at the instance of receiving the TF. If the STA is addressed in the TF and responds with data frames on an uplink to an AP, the STA restarts the EDCA state variables for the ACs not involved in the uplink MU transmission.

In some embodiments, STAs on receiving a TF freezes EDCA state variables for all ACs to the value at the instance of receiving the TF. If the STA is addressed in the TF and responds with data frames on an uplink to the AP, the STA resumes the EDCA state countdown after transmitting the data frames if more data for the AC remain to be transmitted. If all data frames belonging to an AC were transmitted in response to the TF, the STA resets the EDCA state variables and resumes countdown only on the receipt of new data frames for transmission.

Table 1 shows TXOP durations. As illustrated in Table 1, TXOP durations and MSDU size are closely associated with an access category (such as TXOP size 0 is one MSDU in a TXOP). For example, if AC_BK may be defined by a CWmin (such as 310), CWmax (such as 1023), arbitration inter frame number (AIFSN) (such as 7), and TXOP limit (such as 0).

TABLE 1

| AC | CWmin | CWmax | AIFSN | TXOP Limit |
|---|---|---|---|---|
| AC_BK | 31 | 1023 | 7 | 0 |
| AC_BE | 31 | 1023 | 7 | 0 |
| AC_VI | 15 | 31 | 2 | 3.008 ms |
| VC_VO | 7 | 15 | 2 | 1.504 ms |
| Legacy | 15 | 1023 | 2 | 0 |

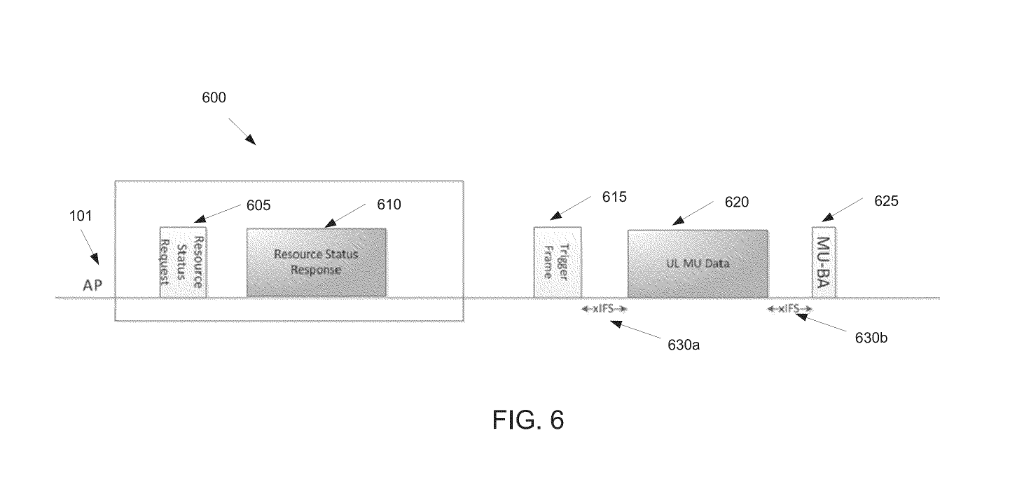

FIG. 6 illustrates an example signal transmission 600 for management of uplink multi user (MU) transmissions according to illustrative embodiments of the present disclosure. The embodiment of the signal flowchart 600 for management of uplink MU transmission illustrated in FIG. 6 is for illustration only. Other embodiments of the signal flowchart 600 could be used without departing from the scope of this disclosure.

As illustrated in FIG. 6 the STAs 111-113 and the AP 101 are configured to perform uplink (UL) MU transmission using a UL MU transmission protocol. The UL transmission from STAs 111-114 to AP 101 in WLANs is initiated by the AP 101. The wireless medium in local area networks like IEEE 802.11 is accessed by contention from all devices in the network using a carrier sense multiple access (CSMA) protocol. For UL transmissions, the AP 101 transmits a resource status request 605 to the STAs 111-114 and receives a resource status response from the STAs 111-114. And then, the AP 101 gains access to or “wins” the wireless medium access and transmits trigger frames 615 indicating that this transmission opportunity (TXOP) is reserved for the UL transmission from multiple STAs. The trigger frame 615 identifies which STAs are to transmit the UL data. The trigger frame 615 is a broadcast frame which can be decoded by all STAs 111-113 in the listening or hearing range of the AP 101. On decoding the trigger frame 615, if the address of the STAs listed in the trigger frame 605 matches the STAs address, the STAs 111-113 transmits their data 620, a time duration 630a (such as inter-frame spacing of x (xIFS)) after receiving the trigger frame 615 using the resource specified by the trigger frame 615. All STAs 111-113 addressed in the trigger frame 615 begin transmissions after xIFS time durations 630a after receiving the trigger frame 615. The xIFS durations 630a, 630a specifies a pre-determined inter-frame spacing where the value x is to be determined. After receiving the data from each of the STAs 111-113, the AP 101 may transmit MU-block acknowledgements (BAs) 625 the STAs 111-113 scheduled in the UL frame. The MU-BA transmission 625 can occur an xIFS duration 630b after receiving the end-of-frame signaling from each of the STAs 111-113 scheduled in the UL MU transmissions 620.

In some embodiments, the resource status response (such as buffer status response) 610 can be a quality of service (QoS) null frame. Additionally, the STAs 111-113 can also include (or piggyback) their resource status response with one or more data transmissions to the AP 101 by placing the resource status in the QoS header fields of the QoS data frame.

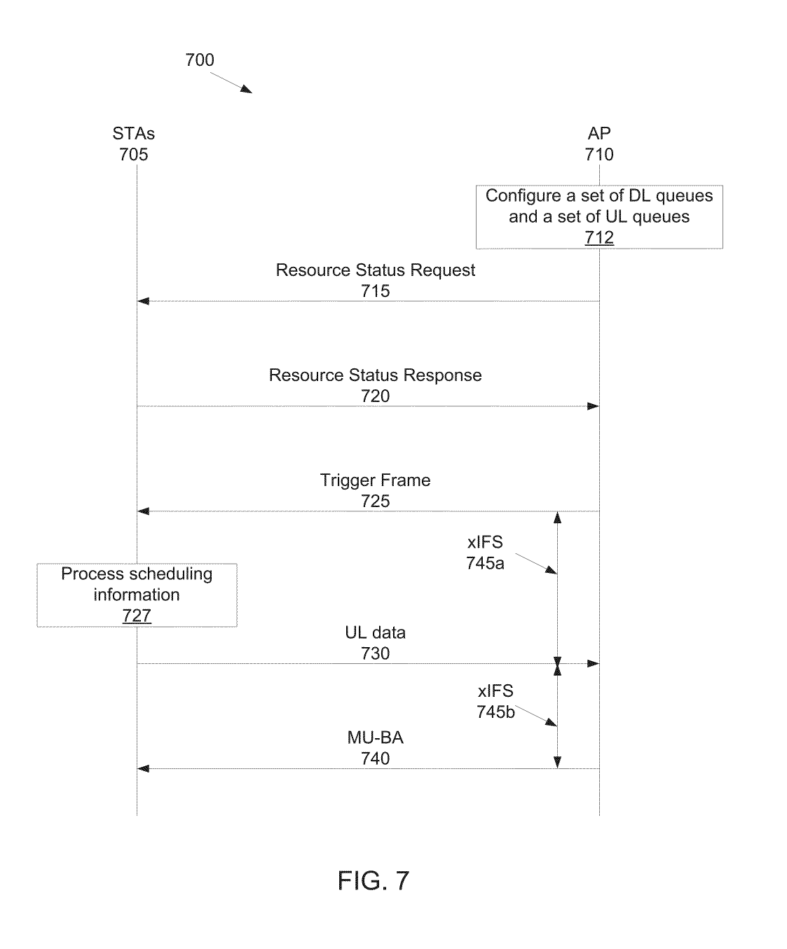

FIG. 7 illustrates an example signal flowchart 700 for uplink MU transmissions according to illustrative embodiments of the present disclosure. The embodiment of the signal flowchart 700 illustrated in FIG. 7 is for illustration only. Other embodiments of the signal flowchart 700 could be used without departing from the scope of this disclosure. As illustrated in FIG. 7 the signal flowchart 700 comprises a set of STAs 705 and an AP 710.

As illustrated in FIG. 7, at step 712, the AP 710 (such as 101 and 103 as illustrated in FIG. 1) configures a set of downlink (DL) queues and a set of uplink (UL) queues that are identified based on an access category (AC) information. The AC information identifies a traffic priority of UL data in accordance with a level of quality of service required by the UL data. In some embodiments, the set of UL queues is identified by single AC information indicating a single traffic priority of the UL data to be transmitted to the AP 710. In some embodiments, at step 712, the AP 710 determines duration of a transmission opportunity (TXOP) and a size of a medium access control (MAC) service data unit (MSDU) based on the AC information corresponding to the set of DL queues and the set of UL queues. In some embodiments, at least one of duration of a TXOP, a size of a MSDU, and the AC information is differently configured for the set of DL queues and the set of UL queues.

At step 715, the AP 710 transmits a resource status request to the set of STAs 705 (such as 111-114 as illustrated in FIG. 1) connecting with the AP 710. When the set of STAs 705 receives the resource status request at step 715, the set of STAs 705 transmits a resource status response in responding to the resource status request at step 720. The resource status response includes the AC information of the UL data to be transmitted to the AP 710. The AC information corresponds to the set of DL queues and the set of UL queues configured at the AP 710 to schedule the set of STAs 705.

When the AP 710 receives the resource status response at step 720 in responding to the resource status request, the AP 710 processes the AC information included in the resource status response received from the set of STAs 705 that will transmit the UL data at step 730. After receiving the resource status response, the AP 710 transmits a trigger frame to the set of STAs at step 725. The trigger frame includes scheduling information of the UL data based on the AC information included in the resource status response received at step 720 from the set of STAs 705.

When the set of STAs 705 receives the trigger frame from the AP 710 at step 725, the set of STAs 705 processes the scheduling information included in the trigger frame at step 727 to transmit the UL data. After processing the scheduling information at step 727, the set of STAs 705 transmits the UL data at step 730 over a granted UL access channel using a UL-multiuser (UL-MU) transmission. The UL data transmitted at step 730 corresponds to the AC information included in the resource status response transmitted at step 720.

In some embodiments, the set of STAs 705 transmits another UL data to the AP 710 until duration of an TXOP expired after transmitting the scheduled UL data (such as transmitted at step 730) corresponding to the AC information included in the transmitted resource status response for the duration of the XTOP. In such instance, the other UL data corresponds to different AC information than the scheduled UL data transmitted at step 730. In some embodiments, the UL data transmitted in the duration of the TXOP includes different ACs information. In some embodiments, the duration of the TXOP is shared in at least one of a time domain, a frequency domain, and a spatial domain.

The AP 710 receives the UL data at step 730 from the set of STAs 705 after an amount of inter-frame space (IFS) 745a. The AP 710 processes the UL data received from the set of STAs 705 and transmits, at step 740, an MU-BA to the set of STAs 705 that have transmitted the UL data at step 730 to the AP 710. In such instance, the MU-BA 740 includes one or more acknowledgements that indicate a successful reception of the UL data from the set of STAs 705.

The set of STAs 705 receives, at step 740, the MU-BA from the AP 710 after an amount of xIFS 745b. The MU-BA includes one or more acknowledgements indicating a successful transmission of the UL data transmitted to the AP 710 at step 730.

In some embodiments, when an uplink transmission from a STA follows a downlink allocation to a set of STAs, at least one of the set of STAs scheduled on the uplink has traffic to send in the same AC as downlink that won a contention for a channel according to an EDCA rules.

In some embodiments, duration of a TXOP and an MSDU limit per AC set differently set at an AP from a set of STAs.

In some embodiments, duration of a TXOP for an uplink DL transmission is decided at an AP irrespective of an AC that won a contention.

In some embodiments, duration of a TXOP may be shared in time domain, frequency, or spatial domains. When the duration of the TXOP is shared in the frequency and spatial domains, the PPDU duration of packets sharing the TXOP may be the same duration.

In some embodiments, a queue for an AC and duration of a TXOP per AC for an UL data transmission are separately configured from those of a downlink data transmission with the downlink's contention window parameters and queue at the AP.

In some embodiments, a contention mechanism of an AC for UL data transmission that may be time varying or set to start based on fulfilling requirements on the distinctness of the received resource requests.

In some embodiments, an STA that receives a trigger frame and transmits UL data in response to the trigger frame may resets a channel contention window after transmitting the UL data to begin a fresh round of contention for traffic remaining to be sent.

Although the present disclosure has been described with an exemplary embodiment, various changes and modifications may be suggested to one skilled in the art. It is intended that the present disclosure encompass such changes and modifications as fall within the scope of the appended claims.

None of the description in this application should be read as implying that any particular element, step, or function is an essential element that must be included in the claim scope. The scope of patented subject matter is defined only by the claims. Moreover, none of the claims is intended to invoke 35 U.S.C. §112(f) unless the exact words “means for” are followed by a participle.

What is claimed is:

1. A station (STA) in a wireless local area network (WLAN), the STA comprising:
a transceiver configured to:
receive a resource status request from an access point (AP) communicating with the STA;
transmit, to the AP, a resource status response including access category (AC) information of UL data that is identified using a traffic identifier, wherein the AC information corresponds to a set of UL queues configured at the AP to schedule the STA; and
receive, from the AP, a trigger frame including scheduling information of the UL data based on the AC information, and
at least one processor configured to process the scheduling information included in the trigger frame to transmit the UL data.

2. The STA of claim 1, wherein the transceiver is further configured to:
transmit, to the AP, the UL data corresponding to the AC information included in the transmitted resource status response based on the scheduling information included in the received trigger frame over a granted UL access channel using a UL-multiuser (UL-MU) transmission; and
receive a multiuser-block acknowledgement (MU-BA) from the AP, wherein the MU-BA includes one or more acknowledgements indicating a successful transmission of the UL data to the AP.

3. The STA of claim 1, wherein the AC information of the UL data indicates a traffic priority of the UL data in accordance with a level of quality of service required by the UL data.

4. The STA of claim 1, wherein the transceiver is further configured to transmit, to the AP, other UL data corresponding to a different AC than an AC indicated in the AC information when duration of a transmission opportunity (TXOP) indicated in the scheduling information has not expired after transmitting the UL data corresponding to the AC information.

5. The STA of claim 1, wherein the scheduling information included in the trigger frame comprises duration of a TXOP, and a size and number of medium access control (MAC) service data units (MSDUs) for the UL data to be transmitted to the AP.

6. The STA of claim 5, wherein the UL data transmitted in the duration of the TXOP includes different ACs information.

7. The STA of claim 5, wherein the duration of the TXOP is shared in at least one of a time domain, a frequency domain, and a spatial domain.

8. An access point (AP) in a wireless local area network (WLAN), the AP comprising:
at least one processor configured to configure a set of downlink (DL) queues and a set of uplink (UL) queues, wherein each DL and UL queues are identified based on an access category (AC); and
a transceiver configured to:
transmit a resource status request to a set of stations (STAs) communicating with the AP;
receive, from the set of STAs, a resource status response including access category (AC) information of UL data from the set of STAs, wherein the AC information corresponds to the set of DL queues and the set of UL queues configured at the AP to schedule the set of STAs; and
transmit a trigger frame to the set of STAs, wherein the trigger frame includes scheduling information of the UL data based on the AC information included in the received resource status response from the set of STAs.

9. The AP of claim 8, wherein the at least one processor is further configured to determine duration of a transmission opportunity (TXOP) and a size of a medium access control (MAC) service data unit (MSDU) based on the AC information, and the transceiver is further configured to receive the UL data from the set of STAs over a granted UL access channel using a UL multi-user (UL-MU) transmission.

10. The AP of claim 9, wherein the transceiver is further configured to transmit a multiuser-block acknowledgement (MU-BA) to the set of STAs that have transmitted the UL data to the AP, the MU-BA including one or more acknowledgements that indicates a successful reception of the UL data from the set of STAs.

11. The AP of claim 8, wherein the AC information of the UL data indicates a traffic priority of the UL data in accordance with a level of quality of service required by the UL.

12. The AP of claim 8, wherein the set of UL queues is identified by single AC information indicating a single traffic priority of the UL data to be transmitted to the AP.

13. The AP of claim 9, wherein at least one of the duration of the TXOP, the size of the MSDU, and the AC information is differently configured for the set of DL queues and the set of UL queues.

14. A method for operating a station (STA) in a wireless local area network (WLAN), the method comprising:
receiving a resource status request from an access point (AP) communicating with the STA;
transmitting, to the AP, a resource status response including access category (AC) information of UL data that is identified using a traffic identifier, wherein the AC information corresponds to a set of DL queues and a set of UL queues configured at the AP to schedule the STA;
receiving, from the AP, a trigger frame including scheduling information of the UL data based on the AC information; and
processing the scheduling information included in the trigger frame to transmit the UL data to the AP.

15. The method of claim 14, further comprising:
transmitting, to the AP, the UL data in corresponding to the AC information included in the transmitted resource status response based on the scheduling information included in the received trigger frame over a granted UL access channel using a UL-multiuser (UL-MU) transmission; and
receiving a multiuser-block acknowledgement (MU-BA) from the AP, wherein the MU-BA includes one or more acknowledgements indicating a successful transmission of the UL data to the AP.

16. The method of claim 14, wherein the AC information of the UL data identifies a traffic priority of the UL data in accordance with a level of quality of service required by the UL data.

17. The method of claim 14, further comprising transmitting, to the AP, other UL data corresponding to a different AC than an AC indicated in the AC information when duration of a transmission opportunity (TXOP) indicated in the scheduling information has not expired after transmitting the UL data corresponding to the AC information.

18. The method of claim 14, wherein the scheduling information included in the trigger frame comprises duration of a TXOP, and a size and number of medium access control (MAC) service data units (MSDUs) for the UL data to be transmitted to the AP.

19. The method of claim 18, wherein the UL data transmitted in the duration of the TXOP includes different ACs information.

20. The method of claim 18, wherein the duration of the TXOP is shared in at least one of a time domain, a frequency domain, and a spatial domain.
